(19) United States
(12) Patent Application Publication
(10) Pub. No.: US 2008/0148822 A1
(43) Pub. Date: Jun. 26, 2008

(54) Fluidic Gating Device

(76) Inventors: Andrew Peter Phelan, Bedford (GB); Aman Khan, Bedford (GB)

Correspondence Address: FOLEY HOAG, LLP;PATENT GROUP (w/ISA), 155 SEAPORT BLVD., BOSTON, MA, 02210-2600, US

(21) Appl. No.: 11/817,188

(22) PCT Filed: Feb. 22, 2006
(86) PCT No.: PCT/GB06/00619

§ 371 Date: Mar. 7, 2008

(30) Foreign Application Priority Data
Feb. 25, 2005 (GB) 0503921.9
Mar. 31, 2005 (GB) 0506533.9

(51) Int. Cl. G01N 1/00; B01J 19/00; G01N 21/00

(52) U.S. Cl. 73/64.56; 422/68.1; 422/82.05

(57) ABSTRACT

A fluidic gating device may have a plurality of test flow paths, each with an end region. The device may include a fluid reservoir or sample application region provided upstream from at least one indicator flow path. The fluid reservoir or sample application region may be separated from the indicator flow path/s by at least one obstacle to flow. The obstacle to flow may be operably associated with the end region of a test capillary flow path, such that the presence of the test liquid at the end region of an associated test capillary flow path reduces or abolishes the obstacle to flow, thereby allowing a liquid to flow from the fluid reservoir or sample application region and along an indicator flow path.

### FIELD OF THE INVENTION

The present invention relates to an apparatus for, and method of, selectively controlling the flow of liquids and in particular relates to an apparatus and method for detecting a property of a sample liquid, such as the presence and/or amount of a substance of interest in the sample liquid.

### BACKGROUND OF THE INVENTION

Simple disposable assay devices for the detection of analytes in a fluid sample are well-known, such as disclosed by EP291194. Such devices may be designed such that the result of such an assay may be interpreted by eye or by electronic detection means. The advantage of using electronic means is that it avoids interpretation of the result by the user. However a disadvantage is that the device requires a power source such as a battery and electronic components such as an LCD display means, photodetector, photodiode, electronic circuitry, printed circuit board and so on. Disposal of such devices is becoming an issue and directives are now in place in some countries which forbid the disposal of battery or electronic components. With the increase in environmental awareness, particularly in Europe, such directives are expected to become more widespread. There therefore exists the need for a simple disposable assay device which is free from such components but nonetheless is able to provide a result to the user without need for interpretation. Such a result could be a simple YES/NO answer in the case of a pregnancy device or a single result or a result within a certain range.

It is well known to use assay devices which rely on capillarity for the movement of a liquid (e.g. a liquid test sample) within the apparatus. The capillarity may be generated by the use of a capillary flow path (typically a conduit of narrow cross-section) or by the use of a porous matrix within which liquid may advance by capillary flow from pore to pore.

For example, EP 0456699 discloses a capillary flow assay device suitable for testing liquids and, in particular, intended to perform haemagglutination reactions suitable for serotyping assays. The assay device disclosed in EP 0456699 comprises a plurality of flow paths, each of which contains an antibody to a respective blood group antigen. The blood sample is applied to a common sample application site, such that blood starts to flow along each of the plurality of flow paths simultaneously. As the blood flows along the flow paths, it will react with one or more of the antibodies, undergoing agglutination which serves to reduce the rate of capillary flow, or may even block the flow path entirely.

Since each of the plurality of flow paths has the same path length, blood which does not react at all with the agglutinating antibodies will reach the end of the flow path fastest, whereas blood flow along the flow path will be retarded (or possibly prevented entirely) where the blood cells carry antigens which react with the antibodies, such that blood will be slower to reach the end of the flow path (if at all). Thus there is a temporal separation which can be used to identify the blood group of the blood sample in question.

However, such a device may require a degree of skill when interpreting the results since, for example, the user may have to monitor the device constantly whilst performing the assay in order to be sure of observing at the end of which flow path the sample arrived first, otherwise the sample may reach the end of a second flow path shortly afterwards and, if the device has not been under continuous surveillance, it will not be possible to determine the assay result.

Another device suitable for performing serotyping or other agglutination reactions is disclosed in WO 2004/083859. The device disclosed therein avoids the problem noted above by inclusion of an electrical detection means to detect the presence of the sample liquid at the end of the flow path, and electrical display means to display the result of the assay, thereby avoiding the need for continuous monitoring and removing any subjectivity in interpreting the assay result. However, the device disclosed in WO 2004/083859 requires a number of relatively complex components (electrical detection means, signal processing means and display means), and a source of electrical power, rendering the device environmentally unfriendly, complex, delicate and relatively expensive.

The present invention aims, in preferred embodiments, to provide an alternative solution to the problems encountered in prior art devices.

### SUMMARY OF THE INVENTION

In a first aspect, the invention provides a fluidic gating device having a plurality of test flow paths, each with an end region, the device comprising:

a fluid reservoir or sample application region provided upstream from at least one indicator flow path, wherein the fluid reservoir or sample application region is separated from the indicator flow path by at least one obstacle to flow; and wherein the obstacle to flow is operably associated with the end region of a test capillary flow path, such that the presence of a test liquid at the end region of an associated test capillary flow path reduces or abolishes the obstacle to flow, thereby allowing a liquid to flow from the fluid reservoir or sample application region and along an indicator flow path.

In a preferred embodiment, the indicator flow paths are of a capillary dimension.

In another embodiment, the indicator flow paths are fluidically connected to, and upstream of, one or more additional fluidic devices.

A general principle of the present invention is that a liquid (which may be thought of as an “indicator” liquid) is provided or caused to be present in an “indicator” flow path which comprises an obstacle to flow (such as a discontinuity), such that the indicator liquid is unable to flow past the obstacle until the resistance to liquid flow provided by the obstacle is overcome by the arrival of a test liquid at the obstacle. The obstacle to the flow of indicator liquid is thus insuperable unless and until the test liquid has reached the obstacle, the arrival of the test liquid then rendering the obstacle superable. Thus the presence of the indicator liquid in the indicator flow path “indicates” that the obstacle to flow has been overcome, which in turn indicates that a test liquid has reached the end region of a test capillary flow path.

The arrival of the test liquid might facilitate lessening or abolition of the obstacle in any of a number of ways. For example, the obstacle may be a solid or semi-solid obstruction of the indicator flow path, which obstruction is dissolved or liquefied in the presence of the test liquid. In a preferred alternative embodiment, the obstacle is created by a discontinuity or “break” formed in the indicator flow path, such that the indicator liquid cannot flow past the discontinuity. Typically the discontinuity is created by the bore of a flow path which conducts the test liquid to the obstacle. Conveniently, each test capillary flow path forms a T-junction or similar union with a respective indicator liquid flow path. When the test liquid reaches the end region of the test capillary flow path (i.e. arrives at the discontinuity in the indicator flow path) the presence of the test liquid acts as a bridge across the discontinuity, thereby allowing the indicator liquid to flow past the discontinuity, into an “indicator region” downstream of the discontinuity.

In this way, the presence of the indicator liquid in the indicator region signals or indicates that the test liquid has arrived at the end of the test capillary flow path.

In a particular embodiment the indicator liquid may be provided or caused to be present in a chamber or reservoir, having a plurality of outlets (each outlet leading to a respective indicator region), but wherein each outlet is provided with an obstacle typically (but not necessarily) immediately downstream of the chamber or reservoir, and wherein each obstacle is itself operably associated with the end region of a test capillary flow path. The flow path by which the test liquid first reaches the test capillary flow path end region thus determines which of the plurality of obstacles is first reduced or abolished, allowing the indicator liquid to flow past the respective obstacle and into the associated indicator region. The obstacles may thus be thought of as a plurality of “gates” which are initially closed, preventing the advance of the indicator liquid, but wherein one particular gate will be opened by the arrival of the test liquid.

The foregoing arrangement does not necessarily prevent indicator liquid flowing through a different “gate” (i.e. past a different obstacle) in another outlet from the chamber or reservoir, when the test liquid arrives at the end region of a second or further test capillary flow path. In some circumstances, the possibility of the test liquid flowing into a second or further outlet or indicator region may be desired. An advantageous feature of providing the possibility of flow of liquid into a second region is that it enables the device to provide an intermediate result, namely where the result is such that it would be inappropriate to provide an absolute or YES/NO type of answer. The indicator regions may be provided with means which is able to measure the amount or presence of liquid in each region. For example, the indicator regions may be provided with a series of windows or a linearly scaled window to provide a visual indication of the extent of filling. The parameters of the device may be chosen in order to define a range of values in which an intermediate result would be given.

Alternatively it may be desired to construct and arrange the device such that indicator liquid can flow past only the first obstacle to be reduced or abolished.

A number of ways of accomplishing this objective can be envisaged. In one embodiment the volume of indicator liquid and arrangement of the flow paths etc. is such that substantially all of the indicator liquid exits from a chamber or reservoir as soon as the first obstacle is removed, or sufficient liquid is withdrawn such that a break is formed between the chamber or reservoir and the other outlets, such that liquid cannot flow into the other outlets even if the obstacles therein are subsequently removed by the arrival of test liquid at the end of the associated test flow paths. In an alternative embodiment, passage of the indicator liquid into the region downstream of the obstacle causes an exothermic reaction to take place, the heat of which causes the obstacles in the other outlets to adopt a conformation or structure which cannot be displaced by the subsequent arrival of test liquid.

The device may be used to determine or measure a property of a liquid sample, such as a viscosity, surface tension or flow rate. In particular a property of the liquid which is measured may be imparted to the liquid, or altered, by interaction of the liquid with one or more reagents (preferably, but not necessarily, located on or within the device): for example, the interaction of a blood sample with a coagulation-promoting or haemagglutination-promoting reagent or reagents.

A device in accordance with the invention may be used to determine the presence and/or amount of an analyte in a liquid sample. For example the test sample could be applied to the device and brought into contact with potentially agglutinating reagents (such as antibodies or antigen-binding fragments thereof, such as Fab, Fv, single domain antibodies and the like) in the various test capillary flow paths. The substance of interest may be anything which can participate in an agglutination reaction and may be, for example, an antibody or other immunoglobulin, or any suitable antigen (e.g. a protein or polypeptide, a nucleic acid, polysaccharide or the like). In particular the antigen may be free in solution or suspension or may be cell-bound or cell-associated (with a prokaryotic or eukaryotic cell).

The device could be used, for example, as a serotyping device (e.g. as described in EP 0456699) or as a pregnancy testing device (e.g. as described in WO 2004/083859), or indeed to diagnose any state or condition in which agglutination reactions may be useful for such purpose. In particular, in preferred embodiments, the invention provides an assay device which is inexpensive, simple to manufacture and quick to use, and which requires little skill or knowledge for correct interpretation of the assay result. The device is thus especially suitable for home use and/or point-of-care testing, and will typically (but not necessarily) be intended for disposal after a single use. In preferred embodiments the invention provides an assay device which need not be monitored over a period of time in order to obtain the assay result but may instead merely be inspected once when the assay has been completed, and which avoids the need for complex electrical components and/or a power source.

Those skilled in the art are well acquainted with suitable materials and methods for providing agglutinating reagents within the test flow paths of the device. For example, immobilisation of antibodies or antigen-binding fragments or variants thereof is a matter of routine. Conveniently, to perform agglutination reactions, antibodies or antigen-binding fragments thereof are immobilised on particulate supports (e.g. latex particles) which may in turn be deposited in the flow path by drying of an aqueous slurry. Suitable such reagents are commercially available.

Importantly, the indicator liquid may be the same as the test liquid that flows along the test flow paths. For example, the test flow paths and indicator liquid chamber or reservoir may have a common origin. Alternatively, the indicator liquid and test liquid may be different. It is preferred that the test flow paths have a common origin so that test liquid, once applied to the origin, will simultaneously commence to advance along each of the test flow paths.

If the indicator liquid is different to the test liquid, it may be applied to the device by the user, or it may be pre-loaded into the device by the manufacturer. Clearly, if the indicator liquid is the same as the test liquid, then typically both will be applied to the device by the user.

It is preferred that the sample applied to the device comprises both the test liquid and the indicator liquid, which simplifies the arrangement of the test device. If the test liquid and indicator liquid are different, it is preferred that they be generally compatible, so as to allow the adoption of the preferred assay device format in which the test liquid, when it reaches the end of a test flow path, forms a ‘bridge’ across a discontinuity or capillary break in the indicator liquid flow path. In order to provide such a bridge, the liquids must have some broadly similar properties e.g. both be similar in terms of the hydrophilic/hydrophobic balance, preferably have similar surface tension properties, and so on. The person skilled in the art can readily select an appropriate set of test and indicator liquids, with the benefit of the present disclosure, based on common general knowledge and/or routine trial and error.

The indicator liquid may be any liquid which is capable of generating or giving rise to a signal in the indicator region. Typically, the signal will be a visual signal. A convenient signal is the appearance or formation of a colour in the indicator region. Thus, for example, the indicator liquid may be naturally coloured (e.g. blood) and readily visible. Alternatively, a colour may be artificially imparted to the indicator liquid. This can be achieved in any of numerous methods.

For example, the indicator liquid may be naturally colourless (e.g. water or other colourless liquid) but be mixed with coloured particles which confer colour. In another embodiment the indicator region may comprise a substance which undergoes a colour change itself (or which causes the indicator liquid to undergo a colour change) when contacted with the indicator liquid. For example, the indicator liquid may comprise a pH indicator and the indicator region may comprise a substance (e.g. an acid or a base) which causes a pH change (and hence colour change) upon mixing with the indicator liquid. Alternatively, the indicator region may incorporate a dye in order to change the colour of the liquid.

Another means of causing a visual signal to be formed is to make use of a colour difference between the indicator liquid and one or more walls of a flow path or other conduit within which the liquid is located. For example, a front wall of the indicator region may be colourless and transparent, with a white legend or symbol formed thereon (e.g. by engraving, ink or the like), which legend is invisible against a white-coloured rear wail of the indicator region. However, if an opaque or coloured indicator liquid flows into the indicator region, the white rear wall is obscured and the white legend provided on the front wall becomes visible. Obviously, any other suitable combination of colours could be used in such an arrangement.

A device in accordance with the invention may be used to analyse any suitable liquid sample of biological, industrial or environmental origin. Thus, the test liquid may be, for example, whole blood, plasma, serum, urine, sweat, lachrymal fluid, saliva, or any aqueous liquid comprising an analyte of interest and such liquids may also be used as the indicator liquid.

The test and/or indicator capillary flow paths may conveniently be provided within or formed by solid-sided tubes or open channels. The tubes or channels may be made from glass, synthetic plastics materials, metal or any other suitable material. The width of the bore of such tubes or channels will typically be in the range of 50-500 μm. Preferably the flow paths will be of a capillary dimension, such that fluid is able to flow along them by capillary action.

The length of the test flow paths may be any length that is suitable to allow sufficient time to elapse for the test liquid to undergo an agglutination reaction before reaching the end of the flow path. This will depend on several properties, such as the concentration of the analyte, the concentration of agglutinating antibody or antigen-binding sites, and so on. Typically, the flow paths will be about 50-500 mm in length. The flow paths may be linear but more preferably will follow a serpentine or convoluted path, in order to reduce the length of the assay device.

The geometry and arrangement of tubes or channels within the device is flexible and amenable to variation. Thus, for example, the number of flow paths may be 2, 3, 4, 5, 6, 7 or more, although typically between 2 and 5 will be normal. The term “test flow path” is intended simply to distinguish such test flow paths from the indicator flow paths—the test flow path could, for example, comprise a positive or negative control flow path. The flow paths may be of the same length or of differing lengths.

A control flow path may comprise a reagent or reagents in order to provide a controlled flow time, against which the result from the test flow path may be compared. Alternatively, or additionally, a controlled flow time of fluid along the control flow path may be achieved by choosing a flow path of a certain length or by incorporating certain microfluidic elements. Preferably the controlled time flow is known, within a certain level of accuracy (e.g. +/−1%).

A device in accordance with the invention may comprise several indicator and associated test capillary flow paths, which may be in series and/or in parallel. In a parallel arrangement, for example, two different samples could be subjected to the same (or different) reaction, whilst a series arrangement would allow one sample to be subjected to different assays (e.g. to allow a particular component or analyte to be better characterised).

The device may incorporate any one or more of the following, in any combination: fluidic elements (e.g. a filter); a liquid incubation region; a stepped region; a mixing region; an eddy or flow restriction zone or the like; and a liquid collecting chamber. These features will preferably be used to enhance differences in flow rate between the control and test flow paths. One or more reagents may be provided in the test and/or control flow path. These may be dried or deposited within the flow path, or provided in a chamber of the like.

The device and/or components thereof may be manufactured by conventional techniques appropriate to the materials employed, including (but not limited to) injection moulding, milling, stamping, extrusion and lamination.

In a second aspect the invention provides a method of analysing a sample liquid for a property, especially the presence and/or amount of an analyte or substance of interest, the method comprising the step of applying the sample to a device in accordance with the first aspect.

For the avoidance of doubt, it is hereby expressly stated that any feature described herein as “preferred”, “advantageous”, “desirable”, “convenient” or the like may be employed in the invention in isolation or in any combination with any one or more other features so-described, unless the context dictates otherwise.

The invention will now be further described by way of illustrative example and with reference to the accompanying drawings, in which:

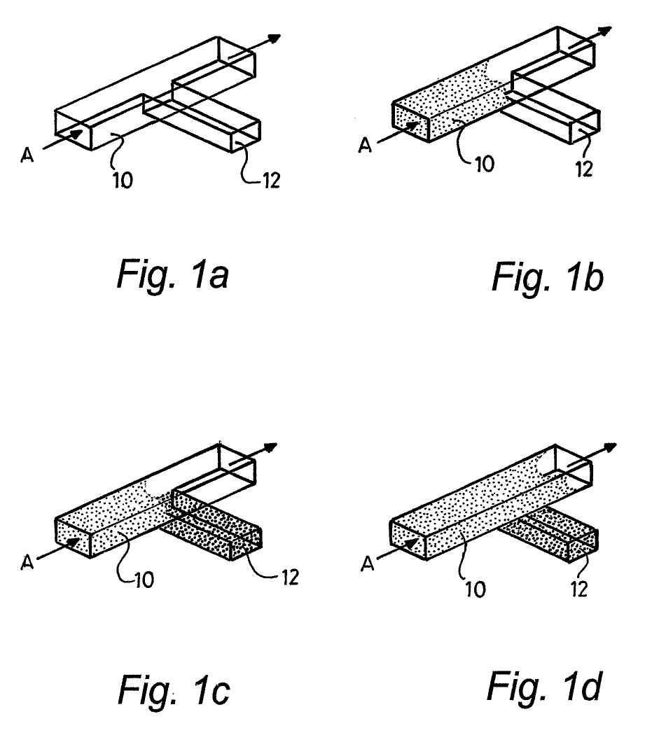

FIGS. 1a-d are schematic illustrations of one example of an obstacle to liquid flow which may be utilised in the device of the invention, and of the manner in which the obstacle may be overcome; and

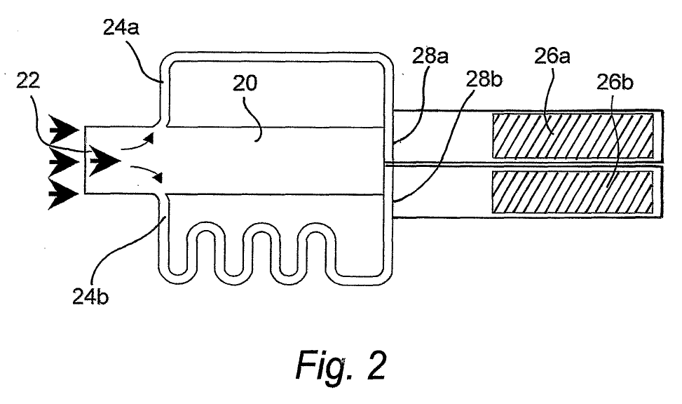

FIG. 2 is a schematic illustration of one embodiment of a device in accordance with the invention.

### EXAMPLES

### Example 1

A preferred method of forming a superable obstacle in the indicator flow path is to create a discontinuity therein, such that indicator liquid cannot advance past the discontinuity by capillary action. Conveniently the discontinuity is formed by the bore of an associated test flow path. In one embodiment, illustrated in FIGS. 1a-d, the test flow path forms a T-junction with the indicator flow path.

A device in accordance with the present invention may comprise a plurality of indicator flow paths (of which one, labelled 10, is shown in FIG. 1a), each indicator flow path having therein a break or discontinuity formed by the bore of an associated test flow path 12.

Indicator liquid (denoted by light shading) introduced into the indicator flow path, moving under the influence of capillarity in the direction indicated by arrow A, is halted by the capillary break formed by the bore of test flow path 12 (as shown in FIG. 1b).

As the assay proceeds, the test liquid (denoted by dark shading) advances along the test flow path 12 and eventually reaches the end region of the test flow path 12 (as shown in FIG. 1c), where it is halted.

The presence of the test liquid at the end of the bore of the test flow path 12 effectively removes the obstacle and allows the indicator liquid to advance past the test flow path 12 towards an indicator region located downstream.

### Example 2

An illustrative embodiment of a device in accordance with the invention is depicted schematically in FIG. 2.

The device comprises a chamber or reservoir 20 having a defined volume. The chamber 20 has an inlet 22 through which a liquid test sample to be analysed can be introduced. Two test flow paths 24a and 24b branch off from the chamber 20 at points equidistant from the inlet 22, such that liquid introduced into the chamber 20 will subsequently start to enter the two test flow paths 24a, b simultaneously.

Two indicator liquid flow paths are provided in the device: one from chamber 20 to downstream indicator region 26a; and one from chamber 20 to indicator region 26b. However, the liquid in the chamber 20 is prevented from advancing by capillarity into either of the downstream indicator regions 26a, b by respective obstacles 28a, b. In this example, the obstacle is created by a break formed by the bore of the respective test flow paths 24a, b, which form T-junctions with the respective indicator liquid flow paths.

In the illustrated example, the same liquid sample acts as both test liquid (flowing along the test capillaries 24a, b) and as indicator liquid (flowing, eventually, from the chamber 20 to one of the indicator regions 26a or 26b). The liquid sample may be, for instance, blood, urine or other body fluid. Within one or both of the test flow paths 24a, b may be deposited agglutinating reagents such as antibodies, which react with a particular antigen which may be present in the sample, a different specificity antibody being provided in the respective test flow paths. Thus as the liquid travels along the test flow paths 24a, b, if a relevant antigen is present it will react with the deposited antibody in one or other of the test flow paths. The resulting agglutination tends to block the flow path or at least increase resistance to flow, thereby preventing or at least retarding the progress of the liquid along the flow path.

In contrast if the relevant antigen is not present in the sample, no agglutination takes place and the progress of the liquid along the flow path is unimpeded. In FIG. 2, one of the test flow paths (24b) is shown as being longer than the other test flow path (24a).

The sample liquid remaining in the chamber 20 functions as an indicator liquid. It substantially fills the chamber but cannot advance past the obstacles 28a, b provided by the capillary breaks constituted by the bores of the test flow paths 24a, b. As explained above, test liquid reaches the end of test flow path 24a before it reaches the end of test flow path 24b. The arrival of the test liquid at the end of the flow path 24a abolishes the break, thereby effectively removing obstacle 28a, allowing the indicator liquid to advance from the chamber into the downstream indicator region 26a (which is separate and discrete from indicator region 26b). The entrance of the indicator fluid into the indicator region 26a causes the formation or appearance of a visual signal. This can be achieved in numerous ways, typically by means of a colour change.

The volume of the indicator region 26a is sufficient to accept substantially all of the liquid from the chamber 20.

As the liquid starts to move into the indicator region 26a, liquid in the chamber 20 is drawn away from contact with the obstacle 28b, effectively increasing the size of the break.

Accordingly, if/when test liquid eventually reaches the end of the test flow path 24b, it will have no effect and the indicator liquid in the chamber 20 will still be unable to enter the downstream indicator region 26b. In this way, the embodiment provides an assay device which need not be continuously monitored in order to be sure of correctly interpreting the assay result since, if the device is left for a reasonable period of time (e.g. 1-24 hrs) after the assay has been completed, the result will not have been altered.

1. A fluidic gating device having a plurality of test flow paths, each with an end region, the device comprising: a fluid reservoir or sample application region provided upstream from at least one indicator flow path, wherein the fluid reservoir or sample application region is separated from the indicator flow path/s by at least one obstacle to flow; and wherein the obstacle to flow is operably associated with the end region of a test capillary flow path, such that the presence of the test liquid at the end region of an associated test capillary flow path reduces or abolishes the obstacle to flow, thereby allowing a liquid to flow from the fluid reservoir or sample application region and along an indicator flow path.

2. A fluidic device according to claim 1, wherein the flow paths are of a capillary dimension.

3. A device according to claim 1, wherein the obstacle in the indicator flow path/s is created by a discontinuity or capillary break.

4. A device according to claim 3, wherein the obstacle in the indicator flow path is formed by the bore of an associated test capillary flow path.

5. A fluidic device according to claim 1, wherein the indicator flow paths are fluidically connected to, and upstream of, one or more additional fluidic devices according to claim 1.

6. A device according to claim 1, wherein each test capillary flow path forms a T-junction with a respective indicator liquid flow path.

7. A device according to claim 1, wherein an indicator liquid is provided or caused to be present in a chamber or reservoir having a plurality of outlets, each outlet leading to a respective indicator region, but wherein each outlet is provided with an obstacle, and wherein each obstacle is operably associated with the end region of a test capillary flow path.

8. A device according to claim 1, wherein a test liquid which flows within the test capillary flow paths is different to an indicator liquid which flows within the indicator flow paths.

9. A device according to claim 1, wherein a test liquid which flows within the test capillary flow paths is the same as an indicator liquid which flows within the indicator flow paths.

10. A device according to claim 1, wherein the device is adapted and arranged to detect the presence and/or amount of an analyte in the test liquid.

11. A device according to claim 10, wherein the test capillary flow paths and/or the indicator flow paths comprise one or more reagents.

12. A device according to claim 1, further comprising an antibody or an antigen-binding fragment thereof.

13. A device according to claim 1, further comprising an indicator region downstream of the obstacle in each indicator flow path.

14. A device according to claim 13, wherein the presence of the indicator liquid in an indicator region generates a signal, preferably a visible signal.

15. A device according to claim 14, wherein the signal is a colour change.

16. A device according to claim 1, comprising one or more control flow paths.

17. A method of analysing a liquid sample for a property, in particular the presence and/or amount of an analyte, the method comprising the step of applying the sample to a device in accordance with claim 1.

18. (canceled)
